(19) United States
(12) Patent Application Publication
(10) Pub. No.: US 2013/0325391 A1
(43) Pub. Date: Dec. 5, 2013

(54) CIRCUIT AND METHOD FOR SENSING TEMPERATURE

(71) Applicant: SAMSUNG ELECTRO-MECHANICS CO., LTD., Gyeonggi-do (KR)

(72) Inventors: Yong Il Kwon, Gyeonggi-do (KR); Jae Hyung Lee, Gyeonggi-do (KR); Byeong Hak Jo, Gyeonggi-do (KR); Tah Joon Park, Gyeonggi-do (KR)

(21) Appl. No.: 13/906,276

(22) Filed: May 30, 2013

(30) Foreign Application Priority Data
May 31, 2012 (KR) 10-2012-0058294

(51) Int. Cl. G01K 7/01

(52) U.S. Cl. CPC G01K 7/01
USPC 702/130; 374/178

(57) ABSTRACT

The present invention relates to a circuit and a method for sensing a temperature. In accordance with an embodiment of the present invention, a circuit for sensing a temperature including: a bipolar transistor unit connected to a current source to output an output voltage which is inversely proportional to temperature; a variable reference voltage unit for providing a variable reference voltage which varies according to setting; a first amplifying unit for receiving the output voltage of the bipolar transistor unit and the variable reference voltage and performing differential amplification to output the amplified voltage; and a second amplifying unit for variably amplifying a variation of the output voltage of the first amplifying unit using a feedback variable resistor is provided. Further, a method for sensing a temperature using the same is provided.

### CROSS-REFERENCE TO RELATED APPLICATIONS

Claim and incorporate by reference domestic priority application and foreign priority application as follows:

### “CROSS REFERENCE TO RELATED APPLICATION

This application claims the benefit under 35 U.S.C. Section 119 of Korean Patent Application Serial No. 10-2012-0058294, entitled filed May 31, 2012, which is hereby incorporated by reference in its entirety into this application.”

### BACKGROUND OF THE INVENTION

1. Field of the Invention

The present invention relates to a circuit and a method for sensing a temperature, and more particularly, to a circuit and a method for sensing a temperature that can measure a temperature very precisely using a simple structure.

2. Description of the Related Art

In case of a basic temperature sensor, a precision temperature sensor is implemented by using a thermistor, which shows a very large change in resistance for temperature changes, and reading the changed value using an analog-digital converter (ADC).

However, since this method has limitations on integration, other methods have been used. The methods basically used in a CMOS are implemented using proportional to absolute temperature (PTAT) and complementary to absolute temperature (CTAT) characteristics.

The basic method of the CMOS temperature sensor uses the PTAT characteristics to measure the changed value simply using a comparator or an ADC. For example, in case of using a comparator, the current mirrored by a current mirror, which has a value proportional to temperature, passes through the resistors distributed in series. Accordingly, a thermal code is output by comparing an output voltage according to distribution resistance, which is proportional to temperature, with a reference voltage of the comparator. This method is very simple, but since a current change due to a temperature change is very small and thus so many comparators and resistor arrays are needed, it is somewhat insufficient to produce an accurate temperature sensor.

Next, in case of using an ADC, an output voltage VPTAT is changed according to temperature. However, since a change in VT according to temperature is less than 0.1 mV, a very precise ADC is required for accurate measurement.

Like this, the method of using the PTAT and CTAT characteristics in the conventional CMOS temperature sensor is simple and can obtain a somewhat precise temperature measurement value. However, since a change in PTAT and CTAT is less than 2 mV/° K, there is a limit to measurement of a very precise temperature.

### RELATED ART DOCUMENT

### Patent Document

Patent Document 1: US Laid-open Patent Publication No. US20070152649A (laid-open on Jul. 5, 2007)

Patent Document 2: US Laid-open Patent Publication No. US20100219879A (laid-open on Sep. 2, 2010)

Patent Document 3: US Laid-open Patent Publication No. US20120004880A (laid-open on Jan. 5, 2012)

### SUMMARY OF THE INVENTION

The present invention has been invented in order to overcome the above-described problems and it is, therefore, an object of the present invention to provide a circuit and a method for sensing a temperature that can measure a temperature very precisely while using a simple structure.

In accordance with a first embodiment of the present invention to achieve the object, there is provided a circuit for measuring a temperature including: a bipolar transistor unit connected to a current source to output an output voltage which is inversely proportional to temperature; a variable reference voltage unit for providing a variable reference voltage which varies according to setting; a first amplifying unit for receiving the output voltage of the bipolar transistor unit and the variable reference voltage and performing differential amplification to output the amplified voltage; and a second amplifying unit for variably amplifying a variation of the output voltage of the first amplifying unit using a feedback variable resistor.

Further, in an example, the bipolar transistor unit has an NPN bipolar transistor, wherein an emitter of the bipolar transistor is connected to ground power, and a collector of the bipolar transistor, which is connected to a current source, and a base of the bipolar transistor are feedback-connected to output a base-emitter voltage V_{BM}, which is inversely proportional to temperature, as an output voltage V1.

Further, in another example, the first amplifying unit has a first differential amplifier, wherein an inverting input terminal of the first differential amplifier may receive the output voltage V1 of the bipolar transistor unit through an input resistor R1 and feedback-receive an output voltage V2 of an output terminal through a feedback resistor R2, and a non-inverting input terminal of the first differential amplifier may receive the variable reference voltage Vsub of the variable reference voltage unit through an input resistor R1 and be connected to the ground power through a ground resistor R2.

Further, in an example, the second amplifying unit has a second differential amplifier, wherein an inverting input terminal of the second differential amplifier may be connected to a negative (−) output terminal of the first amplifying unit through an input resistor R3 and feedback-receive an output voltage V3 of an output terminal through a feedback variable resistor R4, and a non-inverting input terminal of the second differential amplifier may receive a positive (+) terminal output voltage V2 of the first amplifying unit through an input resistor R3 and be connected to a negative (−) output terminal of the second differential amplifier through a variable resistor R4.

At this time, the output voltage V3 of the second amplifying unit can be calculated according to the following formula.

$${V}_{3} = ( 1 + \frac{2 {R}_{4}}{{R}_{3}} ) {V}_{CM} - \frac{2 {R}_{2} {R}_{4}}{{R}_{1} {R}_{3}} ( {V}_{BE} + ( V D D - {V}_{sub} ) )$$

Here, the V_{BE} is the base-emitter voltage, that is, the output voltage of the bipolar transistor unit, the Vsub is the variable reference voltage of the variable reference voltage unit, the R1 is the same of the value of an input resistor R1 between the inverting input terminal of the first differential amplifier of the first amplifying unit and the output voltage VBE and the value of an input resistor R1 between the non-inverting input terminal of the first differential amplifier and the variable reference voltage Vsub, the R2 is the same of the value of a feedback resistor R2 between the inverting input terminal and the output terminal of the first differential amplifier and the value of a ground resistor R2 between the non-inverting input terminal of the first differential amplifier and the ground power, the R3 is the same of the value of the input resistor R3 between the output voltage V2 and the non-inverting input terminal of the second differential amplifier and the value of the input resistor R3 between the negative output terminal of the first amplifying unit and the inverting input terminal of the second differential amplifier, the R4 is the same variable value of the feedback variable resistor R4 between the output voltage V3 and the inverting input terminal of the second differential amplifier and the value of the variable resistor R4 between the non-inverting input terminal and the negative output terminal of the second differential amplifier, the VDD is a power voltage of the second differential amplifier, and V_{CM} is a common mode voltage of the second differential amplifier.

Further, in accordance with an example, the circuit for sensing a temperature in accordance with the above-described first embodiment may further include a temperature calculating unit for calculating a temperature from an output signal of the second amplifying unit, which linearly varies according to temperature.

At this time, in an example, the temperature calculating unit includes an analog-digital converter which converts the output signal of the second amplifying unit into a digital signal to output the digital signal and calculates the temperature from an output value of the analog-digital converter.

Further, in another example, the temperature calculating unit includes a voltage distributing unit for distributing the output voltage of the second amplifying unit; and a comparing unit for comparing outputs of the voltage distributing unit with a comparison reference voltage, and calculates the temperature from an output value of the comparing unit.

Next, in accordance with a second embodiment of the present invention to achieve the object, there is provided a method for sensing a temperature including: (a) outputting an output voltage, which is inversely proportional to temperature, from a bipolar transistor connected to a current source; (b) receiving the output voltage, which is inversely proportional to a temperature, and a variable reference voltage, which varies according to setting, and performing differential amplification to output the amplified voltage; and (c) variably amplifying a variation of the output voltage differentially amplified in the step (b) using a feedback variable resistor.

In another example, in the above step (a), an emitter of the bipolar transistor is connected to ground power, and a collector of the bipolar transistor, which is connected to the current source, and a base of the bipolar transistor are feedback-connected to output a base-emitter voltage V_{BE}, which is inversely proportional to temperature, as an output voltage V1.

Further, in an example, in the above step (b), a non-inverting input terminal of a first differential amplifier connected to the ground power through a ground resistor R2 receives the variable reference voltage Vsub through an input resistor R1, and an inverting input terminal of the first differential amplifier receives the output voltage V1 of the bipolar transistor through an input resistor R1 and feedback-receives an output voltage V2 of an output terminal through the feedback resistor R2 so that the first differential amplifier can differentially amplify the output voltage V1 of the bipolar transistor and the variable reference voltage Vsub to output the amplified voltage.

At this time, in another example, in the above step (c), a non-inverting input terminal of a second differential amplifier connected to a negative (−) output terminal through a variable resistor R4 may receive a positive (+) terminal output voltage V2 of the first differential amplifier through an input resistor R3, and an inverting input terminal of the second differential amplifier connected to a negative (−) output terminal of the first differential amplifier through the input resistor R3 receives an output voltage V3 of the output terminal through the feedback variable resistor R4, so that the second differential amplifier may variably amplify a variation of the output voltage V2 of the first differential amplifier.

Further, in accordance with an example, the method for sensing a temperature in accordance with the above-described second embodiment may further include (d) calculating a temperature from an output signal of the above step (c) which linearly varies according to temperature.

At this time, in an example, the above step (d) may include (d′) converting an analog output signal of the above step (c) into a digital signal to output the digital signal and calculate the temperature from a value output in the step (d′).

Further, in another example, the above step (d) may include (d-1) a voltage distribution step of distributing an output voltage of the above step (c); and (d-2) a comparison step of comparing outputs of the above step (d-1) with a comparison reference voltage and calculate the temperature from a value output in the above step (d-2).

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a block diagram schematically showing a circuit for sensing a temperature in accordance with one embodiment of the present invention;

FIG. 2a is a block diagram schematically showing a circuit for sensing a temperature in accordance with another embodiment of the present invention;

FIG. 2b is a block diagram schematically showing a circuit for sensing a temperature in accordance with another embodiment of the present invention;

FIG. 3 is a circuit diagram schematically showing a circuit for sensing a temperature in accordance with another embodiment of the present invention;

FIG. 4 is a flowchart schematically showing a method for sensing a temperature in accordance with the other embodiment of the present invention;

FIG. 5a is a graph schematically showing an output according to a change in Vsub in the circuit for sensing a temperature of FIG. 3;

FIG. 5b is a graph schematically showing an output according to a feedback variable resistor R4 in the circuit for sensing a temperature of FIG. 3;

FIG. 6 is a graph schematically showing a temperature measurement range of the circuit for sensing a temperature of FIG. 3; and

FIG. 7 is a graph schematically showing a temperature measurement range according to setting from Vsub1 to Vsub8 in the circuit for sensing a temperature of FIG. 3.

### DETAILED DESCRIPTION OF THE PREFERABLE EMBODIMENTS

Embodiments of the present invention to achieve the above-described objects will be described with reference to the accompanying drawings. In this description, the same elements are represented by the same reference numerals, and additional description which is repeated or limits interpretation of the meaning of the invention may be omitted.

In this specification, when an element is referred to as being “connected or coupled to” or “disposed in” another element, it can be “directly” connected or coupled to or “directly” disposed in the other element or connected or coupled to or disposed in the other element with another element interposed therebetween, unless it is referred to as being “directly coupled or connected to” or “directly disposed in” the other element.

Although the singular form is used in this specification, it should be noted that the singular form can be used as the concept representing the plural form unless being contradictory to the concept of the invention or clearly interpreted otherwise. It should be understood that the terms such as “having”, “including”, and “comprising” used herein do not preclude existence or addition of one or more other elements or combination thereof.

First, a circuit for sensing a temperature in accordance with a first embodiment of the present invention will be specifically described with reference to the drawings. At this time, the reference numeral that is not mentioned in the reference drawing may be the reference numeral that represents the same element in another drawing.

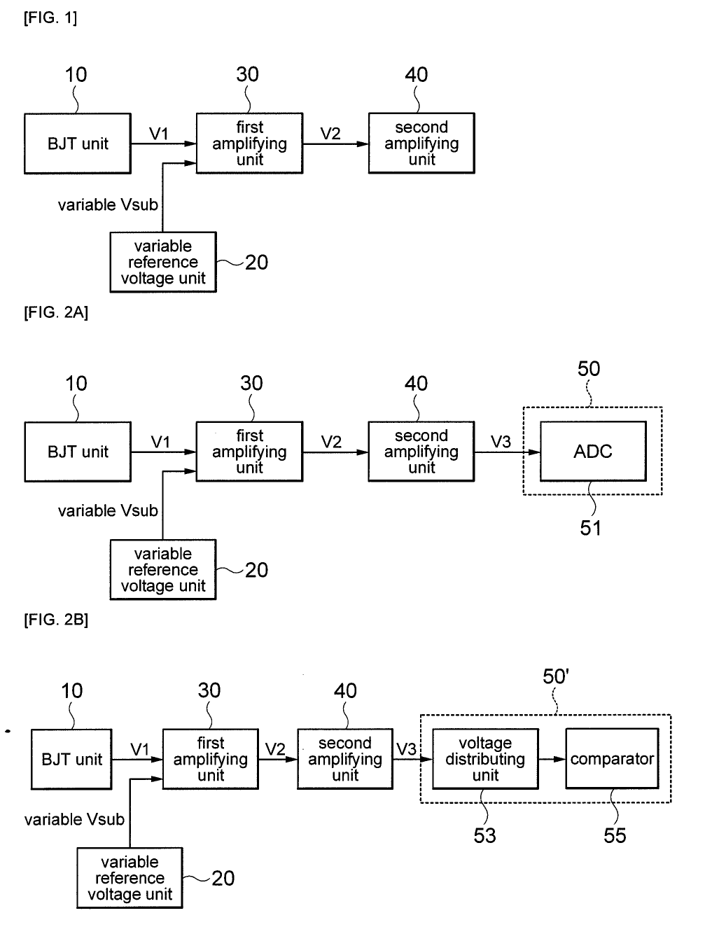

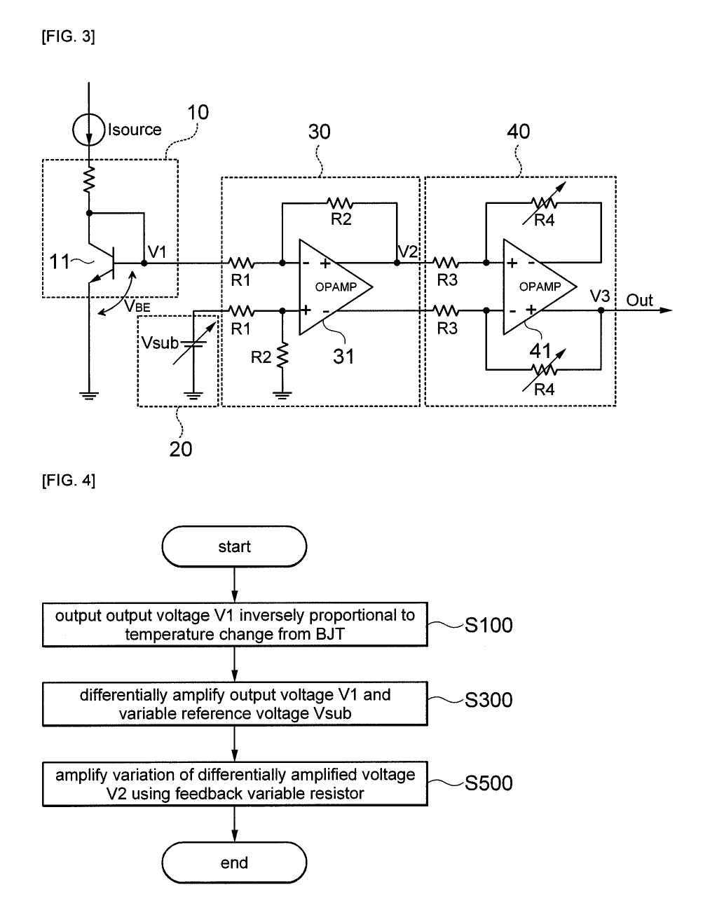

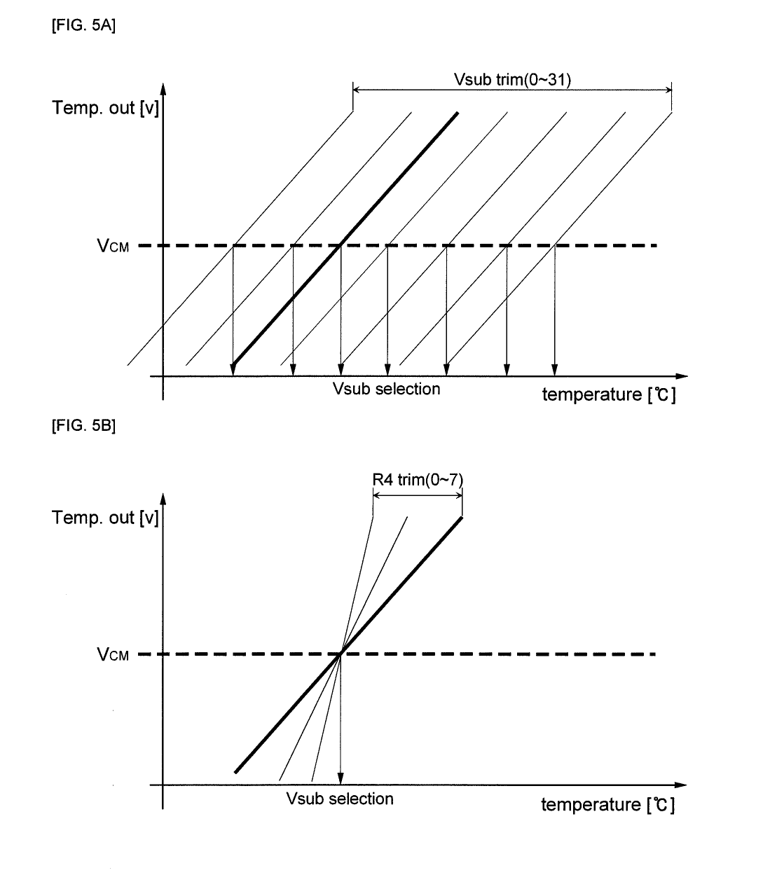

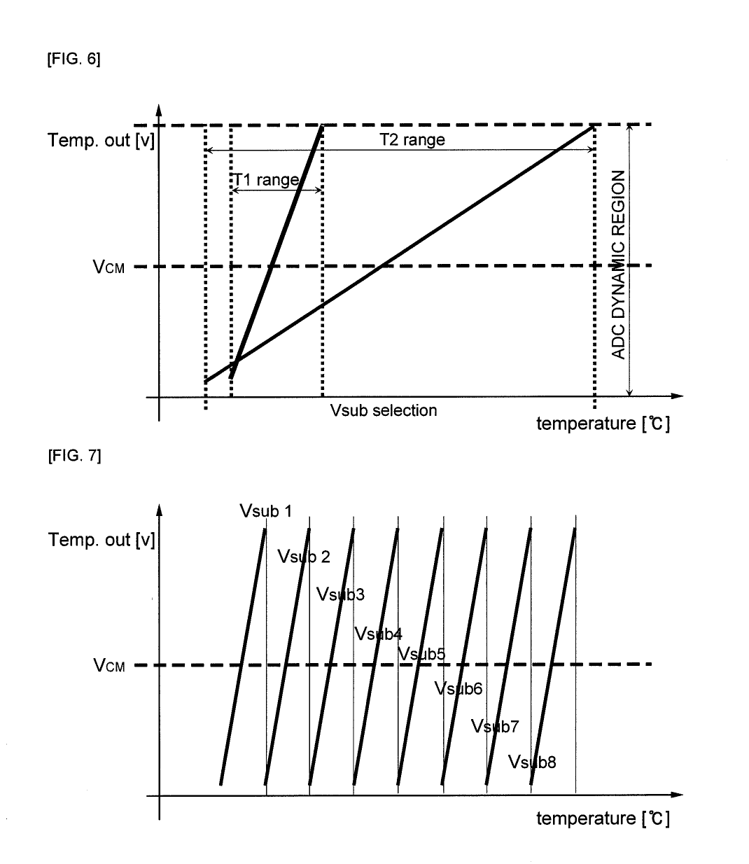

FIG. 1 is a block diagram schematically showing a circuit for sensing a temperature in accordance with one embodiment of the present invention, FIG. 2a is a block diagram schematically showing a circuit for sensing a temperature in accordance with another embodiment of the present invention, FIG. 2b is a block diagram schematically showing a circuit for sensing a temperature in accordance with another embodiment of the present invention, and FIG. 3 is a circuit diagram schematically showing a circuit for sensing a temperature in accordance with another embodiment of the present invention. Further, FIG. 5a is a graph schematically showing an output according to a change in Vsub in the circuit for sensing a temperature of FIG. 3, FIG. 5b is a graph schematically showing an output according to a feedback variable resistor R4 in the circuit for sensing a temperature of FIG. 3, FIG. 6 is a graph schematically showing a temperature measurement range of the circuit for sensing a temperature of FIG. 3, and FIG. 7 is a graph schematically showing a temperature measurement range according to setting from Vsub1 to Vsub8 in the circuit for sensing a temperature of FIG. 3.

First, referring to FIG. 1, a circuit for sensing a temperature in accordance with one embodiment may include a bipolar transistor unit 10, a variable reference voltage unit 20, a first amplifying unit 30, and a second amplifying unit 40. Further, referring to FIGS. 2a and 2b, the circuit for sensing a temperature may further include a temperature calculating unit 50 and 50′. The temperature calculating unit 50 and 50′ will be described later.

The bipolar transistor unit 10 of FIG. 1 is connected to a current source to output an output voltage which is inversely proportional to temperature.

Further, in an example, the bipolar transistor unit 10 has an NPN bipolar transistor 11. An emitter of the bipolar transistor 11 is connected to ground power and a collector of the bipolar transistor 11, which is connected to the current source, and a base of the bipolar transistor 11 are feedback-connected to output a base-emitter voltage V_{BE}, which is inversely proportional to temperature, as an output voltage V1.

Here, a variation of the base-emitter voltage V_{BE} according to temperature is as the following formula (1).

$$\frac{\partial {V}_{BE}}{\partial T} \approx - 1.5 mV \text{/} ° K \qquad Formula ( 1 )$$

Referring to the formula (1), it is possible to know that the base-emitter voltage V_{BE} is linearly inversely proportional to temperature. Accordingly, the circuit for sensing a temperature can be configured so that an output voltage V3, which is obtained by receiving the base-emitter voltage V_{BE} as an input and amplifying the base-emitter voltage V_{BE}, is proportional to temperature.

Continuously, the variable reference voltage unit 20 will be described with reference to FIGS. 1 to 3. The variable reference voltage unit 20 provides a variable reference voltage, which varies according to setting, to the first amplifying unit 20. At this time, the set variable reference voltage Vsub, for example, may vary from Vsub1 to Vsub8 at regular intervals as in FIG. 7. In an embodiment of the present invention, a temperature measurement range is roughly determined according to the variable reference voltage Vsub, and it is possible to precisely measure a temperature by increasing a variation of the output voltage according to a temperature change or measure a temperature in a wide range by reducing the variation of the output voltage according to the temperature change through adjustment of a feedback variable resistor R4 of the second amplifying unit 40 of FIG. 3 which will be described later.

Next, the first amplifying unit 30 of FIG. 1 receives and differentially amplifies the output voltage of the bipolar transistor unit 10 and the variable reference voltage to output the amplified voltage. Referring to FIG. 3, the first amplifying unit 30 subtracts the variable reference voltage Vsub from the output voltage V1 of the bipolar transistor unit 10 to amplify the voltage.

An example will be specifically described with reference to FIG. 3. The first amplifying unit 30 may have a first differential amplifier 31. At this time, an inverting input terminal of the first differential amplifier 31 receives the output voltage V1 of the bipolar transistor unit 10 through an input resistor R1. Further, the inverting input terminal of the first differential amplifier 31 receives an output voltage V2 of an output terminal through a feedback resistor R2. Meanwhile, a non-inverting input terminal of the first differential amplifier 31 receives the variable reference voltage Vsub of the variable reference voltage unit 20 through an input resistor R1 and is connected to the ground power through a ground resistor R2.

Continuously, referring to FIG. 1, the second amplifying unit 40 variably amplifies a variation of the output voltage of the first amplifying unit 30 using the feedback variable resistor. The second amplifying unit 40 amplifies the variation of the output voltage V2 of the first amplifying unit 30 by adjusting the feedback variable resistor R4.

An example will be specifically described with reference to FIG. 3. The second amplifying unit 40 may have a second differential amplifier 41. At this time, an inverting input terminal of the second differential amplifier 41 is connected to a negative (−) output terminal of the first amplifying unit 30, that is, the first differential amplifier 31 of FIG. 3 through an input resistor R3. Further, the inverting input terminal of the second differential amplifier 41 receives the output voltage V3 of the output terminal through the feedback variable resistor R4. Meanwhile, a non-inverting input terminal of the second differential amplifier 41 receives a positive (+) terminal output voltage V2 of the first amplifying unit 30, that is, the first differential amplifier 31 of FIG. 3 and is connected to a negative (−) output terminal through the variable resistor R4. Here, the feedback variable resistor R4 fed back to the inverting terminal and the variable resistor R4 connected to the non-inverting terminal determine an amplification ratio. That is, the variation of the output voltage V2 of the first differential amplifier 31 is amplified in a ratio of R4/R3.

Referring to FIG. 3, the output voltage V3 of the second amplifying unit 40 can be calculated according to the following formula (2) through the first differential amplifier 31 of the first amplifying unit 30 and the second differential amplifier 41 of the second amplifying unit 40.

$${V}_{3} = ( 1 + \frac{2 {R}_{4}}{{R}_{3}} ) {V}_{CM} - \frac{2 {R}_{2} {R}_{4}}{{R}_{1} {R}_{3}} ( {V}_{BE} + ( V D D - {V}_{sub} ) ) \qquad Formula ( 2 )$$

Here, the V_{BE} is the base-emitter voltage, that is, the output voltage of the bipolar transistor unit 10, and the Vsub is the variable reference voltage of the variable reference voltage unit 20. Further, the R1 is the same of the value of an input resistor R1 between the inverting input terminal of the first differential amplifier 31 of the first amplifying unit 30 and the output voltage V_{BE} and the value of an input resistor R1 between the non-inverting input terminal of the first differential amplifier 31 and the variable reference voltage Vsub, and the R2 is the same of the value of a feedback resistor R2 between the inverting input terminal of the first differential amplifier 31 and the output terminal and the value of a ground resistor R2 between the non-inverting input terminal of the first differential amplifier 31 and the ground power at the same time. The R3 is the same of the value of the input resistor R3 between the output voltage V2 and the non-inverting input terminal of the second differential amplifier 41 and the value of the input resistor R3 between the negative output terminal of the first amplifying unit 30 and the inverting input terminal of the second differential amplifier 41, and the R4 is the same variable value of the feedback variable resistor R4 between the output voltage V3 and the inverting input terminal of the second differential amplifier 41 and the value of the variable resistor R4 between the non-inverting input terminal of the second differential amplifier 41 and the negative output terminal of the second differential amplifier 41. And the VDD is a power voltage of the second differential amplifier 41, and the V_{CM} is a common mode voltage of the second differential amplifier 41. Generally, the V_{CM} uses ½ of the VDD or GND according to circuits.

Therefore, referring to the above formula, it is possible to know that the output voltage V3 reflects a value of the base-emitter voltage V_{BE} of the bipolar transistor 11 according to the temperature change.

Next, another example of the circuit for sensing a temperature in accordance with the above first embodiment will be described with reference to FIGS. 2a and 2b.

Referring to FIGS. 2a and 2b, in an example, the circuit for sensing a temperature may further include the temperature calculating unit 50 and 50′. At this time, the temperature calculating unit 50 and 50′ can calculate a temperature from an output signal of the second amplifying unit 40, which linearly varies according to temperature.

Referring to FIG. 2a, in an example, the temperature calculating unit 50 may include an analog-digital converter 51 which converts the output signal of the second amplifying unit 40 into a digital signal to output the digital signal. At this time, the temperature calculating unit 50 can calculate the temperature from a value output from the analog-digital converter 51.

A method of calculating a temperature using the analog-digital converter 51 will be described. For example, let's assume that the range of a voltage input to the analog-digital converter 51 is 0 to 2V. For example, when manufacturing a temperature sensor in the factor, if a measurement value 1V is 30° C. and a measurement value 1.5V is 50° C., the slope formula: y=40x−10 is obtained. Here, y is a temperature, and x is a voltage input to the ADC 51 or a digital value output from the ADC 51. That is, when x=1.2V, a temperature is 38° C.

Further, referring to FIG. 2b, in another example, the temperature calculating unit 50′ may include a voltage distributing unit 53 and a comparing unit 55. At this time, the voltage distributing unit 53 distributes the output voltage of the second amplifying unit 40. Further, the comparing unit 55 compares outputs of the voltage distributing unit 53 with a comparison reference voltage. Accordingly, the temperature calculating unit 50′ can calculate the temperature from an output value of the comparing unit 55. When using a plurality of comparators, since it becomes similar to the ADC 51 of FIG. 2a, it is possible to calculate a temperature by including the comparing unit 55 with the same method as the above temperature calculation using the ADC 51. However, the comparator may have a lower resolution than the ADC 51.

Next, operation results or effects of the circuit for sensing a temperature in accordance with the embodiment of the present invention will be described with reference to FIGS. 5a, 5b, 6, and 7.

At this time, FIG. 5a is a graph schematically showing an output according to a change in the variable reference voltage Vsub in the circuit for sensing a temperature of FIG. 3. Referring to FIG. 5a, it is possible to know that the temperature measurement range according to the output voltage varies according to the change in the variable reference voltage Vsub. That is, it is possible to increase or reduce the temperature measurement range by varying the variable reference voltage Vsub.

FIG. 5b is a graph schematically showing an output according to the feedback variable resistor R4 in the circuit for sensing a temperature of FIG. 3. Referring to FIG. 5b, it is possible to know that the slope of the temperature change according to the output voltage is changed by adjusting the feedback variable resistor R4. As the size of the feedback variable resistor R4 is reduced, since the slope becomes sharp, the temperature change according to the output voltage is reduced. Accordingly, it is possible to precisely measure a temperature. On the contrary, as the size of the feedback variable resistor R4 is increased, the slope becomes gentle and the temperature change according to the output voltage is increased. Accordingly, it is possible to measure a temperature in a wide range.

FIG. 6 is a graph schematically showing the temperature measurement range of the circuit for sensing a temperature of FIG. 3. FIG. 6 shows the graph in which the characteristics of FIGS. 5a and 5b are mixed. That is, in FIG. 3, it is possible to precisely measure a temperature or measure a temperature in a wide interval by determining a temperature measurement interval according to the selection of the variable reference voltage Vsub and adjusting the size of the feedback variable resistor R4. That is, as shown in FIG. 6, it is possible to change the temperature measurement range to ‘T1 range’ and ‘T2 range’ by adjusting the feedback variable resistor R4 and the variable reference voltage Vsub. At this time, since a solid line which represents the ‘T1 range’ reduces the temperature measurement range while increasing the variation of the output voltage according to the temperature change, it is possible to very precisely measure a temperature.

FIG. 7 is a graph schematically showing the temperature measurement range according to setting from Vsub1 to Vsub8 in the circuit for sensing a temperature of FIG. 3. For example, in FIG. 7, in case of Vsub1, an output of 0 to 1.8V appears in the range of −40° C. to −30° C., in case of Vsub2, the output of 0 to 1.8V appears in the range of −30° C. to −20° C., in case of Vsub3, the output of 0 to 1.8V appears in the range of −20° C. to −10° C., in case of Vsub4, the output of 0 to 1.8V appears in the range of −10° C. to 0° C., in case of Vsub5, the output of 0 to 1.8V appears in the range of 0° C. to 10° C., in case of Vsub6, the output of 0 to 1.8V appears in the range of 10° C. to 20° C., in case of Vsub7, the output of 0 to 1.8V appears in the range of 20° C. to 30° C., and in case of Vsub8, the output of 0 to 1.8V appears in the range of 30° C. to 40° C.

Therefore, when the output is read by the ADC (or comparator) of the temperature calculating unit 50 and 50′, when set to Vsub1, a value of the ADC is read in the range of −40° C. to −30° C., and when set to Vsub2, a temperature of −30° C. to −20° C. is read. That is, it is possible to very precisely measure a temperature while satisfying the desired whole range by performing calculation by adding a temperature as much as an offset generated by each Vsub. Accordingly, even using an ADC with very low specifications, it is possible to implement a high precision temperature sensor which can measure a temperature change in a very wide range.

Next, a method for sensing a temperature in accordance with a second embodiment will be specifically described with reference to the drawing. At this time, it is possible to refer to the circuit for sensing a temperature in accordance with the above first embodiment and FIGS. 1 to 4 and 5a to 7. Accordingly, repeated descriptions may be omitted.

FIG. 4 is a flowchart schematically showing a method for sensing a temperature in accordance with the other embodiment of the present invention.

Referring to FIG. 4, the method for sensing a temperature in accordance with an embodiment may include the following steps (a) to (c) (S100 to S300).

Specifically, in the step (a) (S100) of FIG. 4, a bipolar transistor 11 connected to a current source outputs an output voltage which is inversely proportional to temperature.

Another example will be described by additionally referring to FIG. 3. In the above step (a) (S100) of FIG. 4, the bipolar transistor 11 may output a base-emitter voltage V_{BE}, which is inversely proportional to temperature, as an output voltage V1. At this time, an emitter of the bipolar transistor 11 is connected to ground power, and a collector of the bipolar transistor 11, which is connected to the current source, and a base of the bipolar transistor 11 are feedback-connected to output the base-emitter voltage V_{BE}, which is inversely proportional to temperature, as the output voltage V1.

Next, the step (b) (S200) of FIG. 4 receives and differentially amplifies the output voltage, which is inversely proportional to temperature, and a variable reference voltage, which varies according to setting, to output the amplified voltage.

Further, an example will be described by additionally referring to FIG. 3. In the above step (b) (S200) of FIG. 4, differential amplification is performed through a first differential amplifier 31. At this time, a non-inverting input terminal of the first differential amplifier 31 is connected to the ground power through a ground resistor R2. Further, the non-inverting input terminal of the first differential amplifier 31 receives the variable reference voltage Vsub through an input resistor R1. Meanwhile, an inverting input terminal of the first differential amplifier 31 receives the output voltage V1 of the bipolar transistor 11 through the input resistor R1 and receives an output voltage V2 of an output terminal through the feedback resistor R2. Accordingly, the first differential amplifier 31 can differentially amplify the output voltage V1 of the bipolar transistor 11 and the variable reference voltage Vsub to output the voltage V2.

Continuously, in the step (c) (S300) of FIG. 4, a variation of the output voltage differentially amplified in the step (b) (S200) is variably amplified using a feedback variable resistor.

Another example will be described by additionally referring to FIG. 3, in the above (c) step (S300) of FIG. 4, a second differential amplifier 41 can variably amplify a variation of the output voltage V2 of the first differential amplifier 31 by adjusting the feedback variable resistor R4. At this time, a non-inverting input terminal of the second differential amplifier 41 receives a positive (+) terminal output voltage V2 of the first differential amplifier 31 through an input resistor R3 and is connected to a negative (−) output terminal through the variable resistor R4. Further, an inverting input terminal of the second differential amplifier 41 is connected to a negative (−) output terminal of the first differential amplifier 31 through the input resistor R3 and receives an output voltage V3 of the output terminal through the feedback variable resistor R4. Accordingly, the second differential amplifier 41 can variably amplify the variation of the output voltage V2 of the first differential amplifier 31.

Although not shown, another example of the method for sensing a temperature in accordance with the second embodiment will be described with reference to FIGS. 2a and 2b. In accordance with an example, although not shown, the method for sensing a temperature may further include the following step (d) after the above steps (a) to (c) (S100 to S300). Although not shown, in the step (d), it is possible to calculate a temperature from an output signal of the above step (c) (S300), which linearly varies according to temperature.

At this time, although not shown, referring to FIG. 2a, in an example, the above step (d) may include the step (d′) of converting an analog output signal of the above step (c) (S100) into a digital signal to output the digital signal. At this time, it is possible to calculate the temperature from a value output in the step (d′).

Further, although not shown, referring to FIG. 2b, in another example, the above (d) step may further include the following steps (d-1) and (d-2). At this time, in the step (d-1) (not shown), an output voltage of the above step (c) (S300) is distributed. Next, in the step (d-2) (not shown), outputs of the above step (d-1) are compared with a comparison reference voltage. Accordingly, it is possible to calculate the temperature from a value output in the above step (d-2).

According to embodiments of the present invention, it is possible to very precisely measure a temperature while using a simple structure.

Further, according to an embodiment of the present invention, it is possible to increase or reduce a temperature measurement range according to the precision.

Further, according to an embodiment of the present invention, it is possible to implement precise temperature measurement in a very wide range by using a simple ADC or comparator structure.

It is apparent that various effects which have not been directly mentioned according to the various embodiments of the present invention can be derived by those skilled in the art from various constructions according to the embodiments of the present invention.

The above-described embodiments and the accompanying drawings are provided as examples to help understanding of those skilled in the art, not limiting the scope of the present invention. Further, embodiments according to various combinations of the above-described components will be apparently implemented from the foregoing specific descriptions by those skilled in the art. Therefore, the various embodiments of the present invention may be embodied in different forms in a range without departing from the essential concept of the present invention, and the scope of the present invention should be interpreted from the invention defined in the claims. It is to be understood that the present invention includes various modifications, substitutions, and equivalents by those skilled in the art.

What is claimed is:

1. A circuit for sensing a temperature, comprising:
a bipolar transistor unit connected to a current source to output an output voltage which is inversely proportional to temperature;
a variable reference voltage unit for providing a variable reference voltage which varies according to setting;
a first amplifying unit for receiving the output voltage of the bipolar transistor unit and the variable reference voltage and performing differential amplification to output the amplified voltage; and
a second amplifying unit for variably amplifying a variation of the output voltage of the first amplifying unit using a feedback variable resistor.

2. The circuit for sensing a temperature according to claim 1, wherein the bipolar transistor unit has an NPN bipolar transistor, wherein an emitter of the bipolar transistor is connected to ground power, and a collector of the bipolar transistor, which is connected to a current source, and a base of the bipolar transistor are feedback-connected to output a base-emitter voltage V_{BM}, which is inversely proportional to temperature, as an output voltage V1.

3. The circuit for sensing a temperature according to claim 1, wherein the first amplifying unit has a first differential amplifier, wherein
an inverting input terminal of the first differential amplifier receives the output voltage V1 of the bipolar transistor unit through an input resistor R1 and feedback-receives an output voltage V2 of an output terminal through a feedback resistor R2, and
a non-inverting input terminal of the first differential amplifier receives the variable reference voltage Vsub of the variable reference voltage unit through an input resistor R1 and is connected to the ground power through a ground resistor R2.

4. The circuit for sensing a temperature according to claim 1, wherein the second amplifying unit has a second differential amplifier, wherein
an inverting input terminal of the second differential amplifier is connected to a negative (−) output terminal of the first amplifying unit through an input resistor R3 and feedback-receives an output voltage V3 of an output terminal through a feedback variable resistor R4, and
a non-inverting input terminal of the second differential amplifier receives a positive (+) terminal output voltage V2 of the first amplifying unit through an input resistor R3 and is connected to a negative (−) output terminal of the second differential amplifier through a variable resistor R4.

5. The circuit for sensing a temperature according to claim 4, wherein the output voltage V3 of the second amplifying unit is calculated according to the following formula:
$${V}_{3} = ( 1 + \frac{2 {R}_{4}}{{R}_{3}} ) {V}_{CM} - \frac{2 {R}_{2} {R}_{4}}{{R}_{1} {R}_{3}} ( {V}_{BE} + ( V D D - {V}_{sub} ) )$$
Here, the V_{BE} is the base-emitter voltage, that is, the output voltage of the bipolar transistor unit, the Vsub is the variable reference voltage of the variable reference voltage unit, the R1 is the same of the value of an input resistor R1 between the inverting input terminal of the first differential amplifier of the first amplifying unit and the output voltage VBE and the value of an input resistor R1 between the non-inverting input terminal of the first differential amplifier and the variable reference voltage Vsub, the R2 is the same of the value of a feedback resistor R2 between the inverting input terminal and the output terminal of the first differential amplifier and the value of a ground resistor R2 between the non-inverting input terminal of the first differential amplifier and the ground power, the R3 is the same of the value of the input resistor R3 between the output voltage V2 and the non-inverting input terminal of the second differential amplifier and the value of the input resistor R3 between the negative output terminal of the first amplifying unit and the inverting input terminal of the second differential amplifier, the R4 is the same variable value of the feedback variable resistor R4 between the output voltage V3 and the inverting input terminal of the second differential amplifier and the value of the variable resistor R4 between the non-inverting input terminal and the negative output terminal of the second differential amplifier, the VDD is a power voltage of the second differential amplifier, and the V_{CM} is a common mode voltage of the second differential amplifier.

6. The circuit for sensing a temperature according to claim 1, further comprising:
a temperature calculating unit for calculating a temperature from an output signal of the second amplifying unit, which linearly varies according to temperature.

7. The circuit for sensing a temperature according to claim 3, further comprising:
a temperature calculating unit for calculating a temperature from an output signal of the second amplifying unit, which linearly varies according to temperature.

8. The circuit for sensing a temperature according to claim 4, further comprising:
a temperature calculating unit for calculating a temperature from an output signal of the second amplifying unit, which linearly varies according to temperature.

9. The circuit for sensing a temperature according to claim 5, further comprising:
a temperature calculating unit for calculating a temperature from an output signal of the second amplifying unit, which linearly varies according to temperature.

10. The circuit for sensing a temperature according to claim 6, wherein the temperature calculating unit comprises an analog-digital converter which converts the output signal of the second amplifying unit into a digital signal to output the digital signal and calculates the temperature from an output value of the analog-digital converter.

11. The circuit for sensing a temperature according to claim 6, wherein the temperature calculating unit comprises a voltage distributing unit for distributing the output voltage of the second amplifying unit and a comparing unit for comparing outputs of the voltage distributing unit with a comparison reference voltage, and calculates the temperature from an output value of the comparing unit.

12. A method for sensing a temperature, comprising:
(a) outputting an output voltage, which is inversely proportional to temperature, from a bipolar transistor connected to a current source;
(b) receiving the output voltage, which is inversely proportional to temperature, and a variable reference voltage, which varies according to setting, and performing differential amplification to output the amplified voltage; and
(c) variably amplifying a variation of the output voltage differentially amplified in the step (b) using a feedback variable resistor.

13. The method for sensing a temperature according to claim 12, wherein in the step (a), an emitter of the bipolar transistor is connected to ground power, and a collector of the bipolar transistor, which is connected to the current source, and a base of the bipolar transistor are feedback-connected to output a base-emitter voltage V_{BE}, which is inversely proportional to temperature, as an output voltage V1.

14. The method for sensing a temperature according to claim 12, wherein in the step (b), a non-inverting input terminal of a first differential amplifier connected to the ground power through a ground resistor R2 receives the variable reference voltage Vsub through an input resistor R1, and an inverting input terminal of the first differential amplifier receives the output voltage V1 of the bipolar transistor through an input resistor R1 and receives an output voltage V2 of an output terminal through the feedback resistor R2 so that the first differential amplifier differentially amplifies the output voltage V1 of the bipolar transistor and the variable reference voltage Vsub to output the amplified voltage.

15. The method for sensing a temperature according to claim 14, wherein in the step (c), a non-inverting input terminal of a second differential amplifier connected to a negative (−) output terminal through a variable resistor R4 receives a positive (+) terminal output voltage V2 of the first differential amplifier through an input resistor R3, and an inverting input terminal of the second differential amplifier connected to a negative (−) output terminal of the first differential amplifier through the input resistor R3 receives an output voltage V3 of the output terminal through the feedback variable resistor R4, so that the second differential amplifier variably amplifies a variation of the output voltage V2 of the first differential amplifier.

16. The method for sensing a temperature according to claim 12, further comprising:
(d) calculating a temperature from an output signal of the step (c) which linearly varies according to temperature.

17. The method for sensing a temperature according to claim 14, further comprising:
(d) calculating a temperature from an output signal of the step (c) which linearly varies according to temperature.

18. The method for sensing a temperature according to claim 15, further comprising:
(d) calculating a temperature from an output signal of the step (c) which linearly varies according to temperature.

19. The method for sensing a temperature according to claim 16, wherein the step (d) comprises (d′) converting an analog output signal of the step (c) into a digital signal to output the digital signal and calculates the temperature from a value output in the step (d′).

20. The method for sensing a temperature according to claim 16, wherein the step (d) comprises (d-1) a voltage distribution step of distributing an output voltage of the step (c); and (d-2) a comparison step of comparing outputs of the step (d-1) with a comparison reference voltage and calculates the temperature from a value output in the step (d-2).
